(19) United States
(12) Patent Application Publication
(10) Pub. No.: US 2025/0196808 A1
(43) Pub. Date: Jun. 19, 2025

(54) WINDOW GLASS FOR VEHICLE

(71) Applicant: AGC Inc., Tokyo (JP)

(72) Inventors: Satoshi KANEKO, Tokyo (JP); Hideaki Shoji, Tokyo (JP); Shoichi Takeuchi, Tokyo (JP); Kiyoshi Nobuoka, Tokyo (JP)

(73) Assignee: AGC Inc., Tokyo (JP)

(21) Appl. No.: 19/072,690

(22) Filed: Mar. 6, 2025

Related U.S. Application Data
(63) Continuation of application No. PCT/JP2023/031127, filed on Aug. 29, 2023.

(30) Foreign Application Priority Data
Sep. 12, 2022 (JP) 2022-144492

(51) Int. Cl. B60S 1/02; B32B 17/10; B60J 1/00; H05B 3/86

(52) U.S. Cl. CPC B60S 1/026; B32B 17/10036; B32B 17/10385; B60J 1/001; H05B 3/86; B32B 2605/00

(57) ABSTRACT

The window glass for vehicle includes a heating section provided between a second main surface and a third main surface and connected between a upper edge bus bar and a lower edge bus bar. The heating section has first heating wires provided in the first region and connected between the upper edge bus bar and the lower edge bus bar and second heating wires provided in the second region and connected between the upper edge bus bar and the lower edge bus bar. A first pitch between the first heating wires in the width direction of the vehicle body is wider than a second pitch between the second heating wires in the width direction of the vehicle body.

### INCORPORATION BY REFERENCE

This application is based upon and claims the benefit of priority from Japanese Patent Application No. 2022-144492 filed on Sep. 12, 2022, and PCT application No. PCT/JP2023/031127 filed on Aug. 29, 2023, the disclosure of which is incorporated herein in its entirety by reference.

### BACKGROUND

The present disclosure relates to a window glass for vehicle.

Conventionally, there have been electrically heated windows, in each of which at least two plies of a glassy material and at least one ply of an intermediate layer material extending between the plies of the glassy material are stacked. The electrically heated window includes an array of fine wires spaced densely and held by either the two plies or the at least one ply and electrically connecting means for connecting the array to an electricity supply source so as to flow electric current to the wires to heat the window. At least some of the wires extend along a divergent line, and the array extends substantially all over a transparent portion of the window. It is disclosed that an interval between the wires varies depending on a location on the electrically heated window (see Japanese Unexamined Patent Application Publication No. H09-207718, for example).

### SUMMARY

In a conventional electrically heated window (window glass for vehicle) formed of wires (heating wires), the interval between the wires is not widened depending on a location in order to improve transmittivity of an electric wave. Simply widening the interval between the wires causes adverse effects such as a decrease in heat generation temperature and uneven heating. Thus, it is not easy to satisfy both of effective transmittivity of an electric wave and uniform heat generation distributions.

The present disclosure therefore has an object to provide a window glass for vehicle that can satisfy both of effective transmittivity of an electric wave and uniform heat generation distributions.

A window glass for vehicle of an embodiment of the present disclosure includes a laminated glass including a first glass plate having a first main surface and a second main surface, a second glass plate having a third main surface and a fourth main surface, and an intermediate film provided between the second main surface and the third main surface, the laminated glass being provided in an opening of a vehicle body, an upper edge bus bar provided between the second main surface and the third main surface along an upper edge of the laminated glass, a lower edge bus bar provided between the second main surface and the third main surface along a lower edge of the laminated glass, and a heating section provided between the second main surface and the third main surface and connected between the upper edge bus bar and the lower edge bus bar, in which the laminated glass has a first region in which a communication unit is positioned in a width direction of the vehicle body and a second region other than the first region, and the heating section has first heating wires provided in the first region and connected between the upper edge bus bar and the lower edge bus bar and second heating wires provided in the second region and connected between the upper edge bus bar and the lower edge bus bar, and a first pitch between the first heating wires in the width direction of the vehicle body is wider than a second pitch between the second heating wires in the width direction of the vehicle body.

A window glass for vehicle that can satisfy both of effective transmittivity of an electric wave and uniform heat generation distributions can be provided.

The above and other objects, features and advantages of the present disclosure will become more fully understood from the detailed description given hereinbelow and the accompanying drawings.

### BRIEF DESCRIPTION OF DRAWINGS

FIG. 1A is a side view showing an example of a configuration of a vehicle on which a window glass for vehicle of an embodiment is mounted;

FIG. 1B is a view showing the window glass for vehicle and its periphery in FIG. 1A on a larger scale;

FIGS. 2A-2C are diagrams describing a relationship between polarization direction of electric waves and heating wires;

FIG. 3 is a view showing an example of a configuration of the window glass for vehicle of the embodiment in a plan view;

FIG. 4 is a sectional view showing an example of the configuration of the window glass for vehicle in FIG. 3 taken along a line indicated by arrows A-A;

FIG. 5 is a view showing an example of a simulation result of transmitted electrical power;

FIG. 6 is a view showing an example of a configuration of a window glass for vehicle of a first modification of the embodiment in a plan view; and

FIG. 7 is a view showing an example of a configuration of a window glass for vehicle of a second modification of the embodiment in a plan view.

### DESCRIPTION OF EMBODIMENTS

### Embodiment

Hereinafter, an embodiment to which a window glass for vehicle of the present disclosure is applied will be described. Hereinafter, the same elements have the same reference characters allotted, and detailed description thereof will be omitted in some cases. For ease of understanding, a scale of each portion in the drawings differs from an actual one in some cases. The directions such as parallel, perpendicular, orthogonal, up-down, and right-left directions are allowed to deviate to such a degree as not to lessen effects of the embodiment. The shape of each corner is not limited to a perpendicular shape, and may be rounded into a bow shape.

Examples of the window glass for vehicle of the embodiment include a windshield (front window) to be attached to a front portion of a vehicle, a fixed side window glass to be attached to a lateral side of a vehicle, a roof glass to be attached to the ceiling of a vehicle, a rear window glass to be attached to a rear portion of a vehicle, and the like. The window glass for vehicle is not limited to these examples, and may be slidable over a vehicle body. Hereinafter, a mode in which the window glass for vehicle of the embodiment is a windshield (front window) to be attached to the front portion of a vehicle will be described as an example.

A communication instrument is mounted on a vehicle provided with the window glass for vehicle of the embodiment. An electric wave transmitted from the communication instrument to the outside of the vehicle or an electric wave received by the communication instrument from the outside of the vehicle transmits through the window glass for vehicle of the embodiment. It is suitable that an electric wave transmitted/received by the communication instrument should be an electric wave in the band of 5.9 GHZ or 5.8 GHz allocated to V2X (Vehicle to X) communication or an electric wave in a millimeter waveband for the 5th generation mobile communication system (5G) or the like or in a frequency band of 1 GHz to 30 GHz including Sub-6. Alternatively, an electric wave transmitted/received by the window glass for vehicle of the embodiment may be of LTE (Long Term Evolution), LTE-A (LTE-Advanced), or UMB (Ultra Mobile Broadband). Alternatively, an electric wave transmitted/received by the window glass for vehicle of the embodiment may be of IEEE802.11 (Wi-Fi (registered trademark)), IEEE802.16 (WiMAX (registered trademark)), IEEE802.20, UWB (Ultra-Wideband), Bluetooth (registered trademark), LPWA (Low Power Wide Area), or the like. An electric wave transmitted/received by the communication instrument preferably has a frequency of 3 GHZ to 6 GHz, and more preferably has a frequency of 5 GHz to 6 GHz. Hereinafter, description will be given using an electric wave in the band of 5.9 GHz for V2X as an example unless otherwise specified.

### Vehicle 10 on Which Window Glass 100 for Vehicle is Mounted

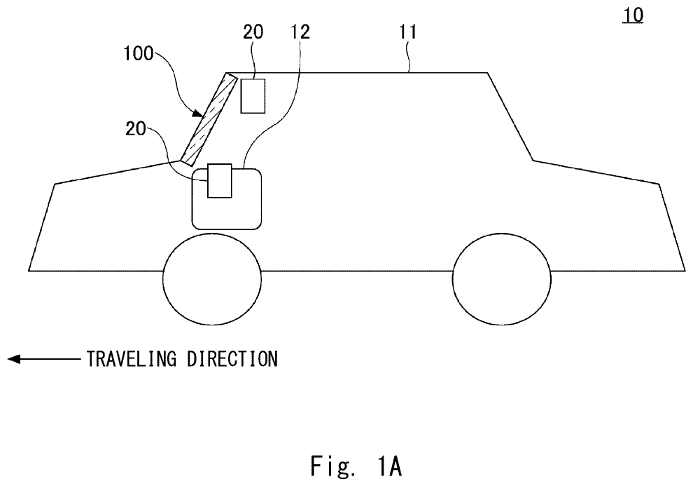

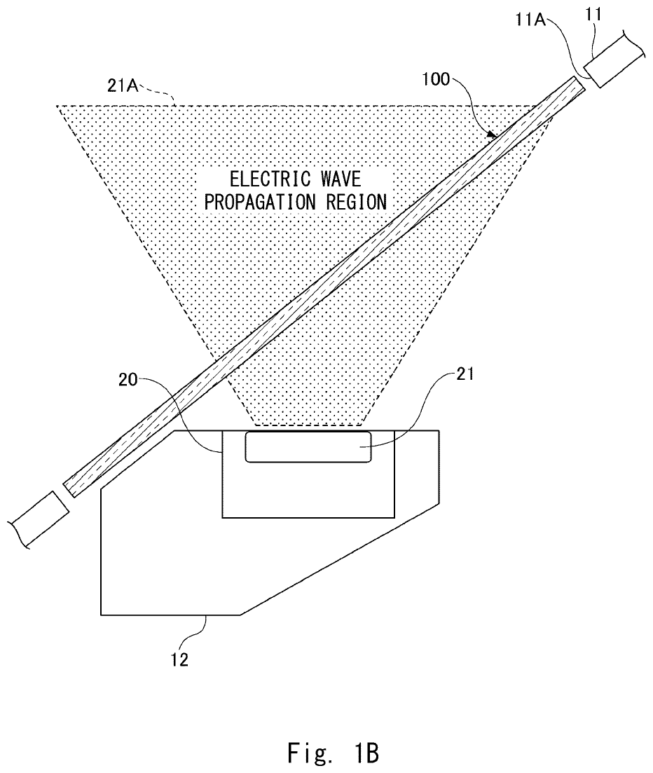

FIG. 1A is a side view showing an example of a configuration of a vehicle 10 on which a window glass 100 for vehicle of an embodiment is mounted. FIG. 1B is a view showing the window glass 100 for vehicle and its periphery in FIG. 1A on a larger scale.

As an example, the window glass 100 for vehicle is attached as a windshield to a window frame 11A of a vehicle body 11 of the vehicle 10. The window frame 11A is an example of an opening of the vehicle body 11. A communication instrument 20 is mounted on the vehicle 10. The communication instrument 20 is an example of a communication unit. As an example, the communication instrument 20 is attached to an upper portion of a dashboard 12 in the room or an upper portion of the window glass 100 for vehicle inside the room. The upper portion of the dashboard 12 may be an inner upper portion of the dashboard 12, or may be an outer upper portion (for example, an upper surface) of the dashboard 12. Although FIG. 1A shows the communication instrument 20 on each of the upper portion of the dashboard 12 and the upper portion of the window glass 100 for vehicle inside the room, the communication instrument 20 may be provided at least at either of the positions. Alternatively, the communication instrument 20 may be provided at a position inside the room with respect to the window glass 100 for vehicle and other than the upper portion of the dashboard 12 or the upper portion of the window glass 100 for vehicle inside the room because the communication instrument 20 may perform communication through the window glass 100 for vehicle.

Although a mode in which the communication instrument 20 is positioned in a central portion in a width direction of the vehicle 10 will be described here as an example, the communication instrument 20 may be provided on the left side or the right side in the width direction of the vehicle 10. The width direction of the vehicle 10 is a lateral direction relative to a traveling direction (a forward direction of the vehicle 10), and the left side and the right side are the left side and the right side when the vehicle 10 is seen in the traveling direction as an example.

The vehicle 10 is, for example, a vehicle such as an EV (Electric Vehicle) car, a PHEV (Plug-in Hybrid Electric Vehicle) car, a HV (Hybrid Vehicle) car, a gasoline car, or a diesel car. Alternatively, the vehicle 10 may be an electric train or a locomotive. The vehicle 10 is an example of a vehicle that moves while carrying a passenger.

The communication instrument 20 is a wireless transceiver for V2X communication as an example, and is a device that sends/receives data to/from another vehicle, (communication terminal equipment such as a smartphone of) a pedestrian, various infrastructures, a network, or the like outside the vehicle 10. Note that the communication instrument 20 is not limited to a communication instrument for V2X communication, and may be a device that performs only one of sending or reception of data.

The communication instrument 20 sends and receives a vertically polarized or circularly polarized electric wave. FIG. 1B shows a configuration in which the communication instrument 20 is provided on the upper portion of the dashboard 12 as an example. The communication instrument 20 has an antenna 21 facing upward. A region (an electric wave propagation region 21A) in which an electric wave transmitted from the antenna 21 propagates is shown by dots in FIG. 1B. The electric wave propagation region 21A is also a region in which an electric wave received by the antenna 21 propagates. A portion in which the electric wave propagation region 21A and the window glass 100 for vehicle intersect with each other is a portion in which an electric wave transmits through the window glass 100 for vehicle. Note that a vertically polarized wave or circularly polarized wave represents a direction of a polarized wave when an electric wave is transmitted/received in the horizontal direction with the antenna 21 of the communication instrument 20 facing in the horizontal direction.

### Relationship Between Polarization Direction of Electric Wave and Heating Wires

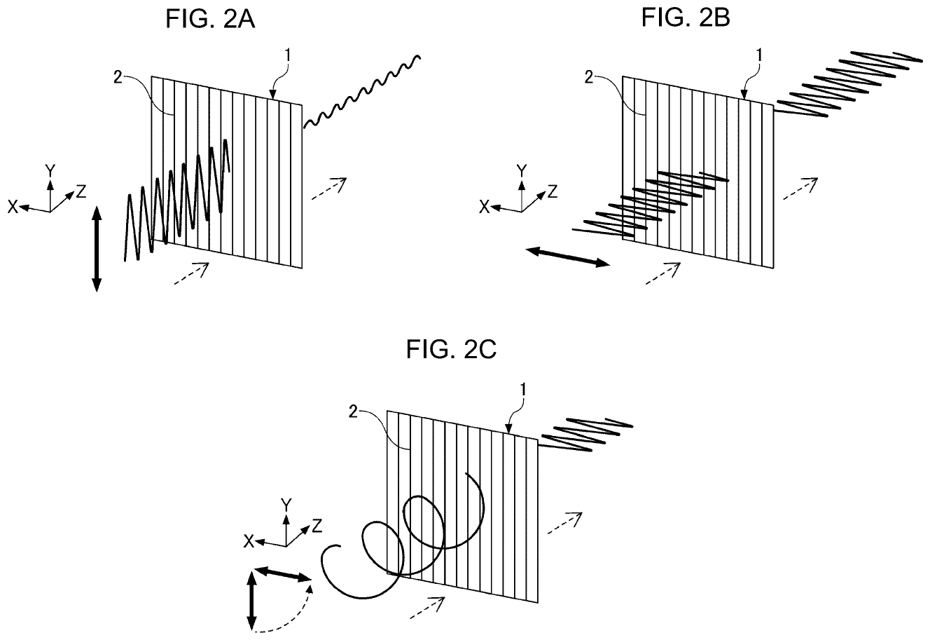

FIGS. 2A-2C are diagrams describing a relationship between polarization direction of an electric wave and heating wires. In FIGS. 2A-2C, the X −Y −Z coordinate system is used. An X-axis direction, a Y-axis direction, and a Z-axis direction represent a direction parallel to an X-axis, a direction parallel to a Y-axis, and a direction parallel to a Z-axis, respectively. The X-axis direction, the Y-axis direction, and the Z-axis direction are orthogonal to one another.

FIG. 2A to FIG. 2C show a window glass 1 for vehicle parallel to an X −Y plane. As an example, the window glass 1 for vehicle is a laminated glass to be used as a windshield (front window), and heating wires 2 extending in the Y-axis direction are provided in the X-axis direction in an intermediate layer at a constant pitch. As an example, the heating wires 2 are tungsten wires. The pitch in the X-axis direction between the heating wires 2 is about 2 mm as an example. Although extending in the Y-axis direction while curving sinusoidally relative to the Y-axis direction within the X −Y plane, the heating wires 2 are shown linearly in FIG. 2A to FIG. 2C because of a very small width of deflection equivalent to an amplitude of a sinusoidal wave.

In addition, a −Z-axis direction side of the window glass 1 for vehicle is inside the room of the vehicle, and a +Z-axis direction side is outside the room of the vehicle, as an example. The X-axis direction is equivalent to the width direction of the vehicle, a +Y-axis direction side is an upward side, and a −Y-axis direction side is a downward side.

The heating wires 2 may function as a deicer that efficiently melts ice or snow adhering to the outermost surface of the window glass 1 for vehicle. In the case in which the heating wires 2 function as the deicer, a value of electric current to be flowed to the heating wires 2 may be set higher (for example, about twice higher) than in a case in which the heating wires 2 function as a defogger that removes haze (water drops) on the surface of the window glass 1 for vehicle. Thus, in the case in which the heating wires 2 are caused to function as the deicer, the heating wires 2 are thicker and has greater influence on a range of view of the window glass 1 for vehicle than in the case in which the heating wires 2 are caused to function as the defogger.

The heating wires 2 are provided in the up-down direction of the vehicle (the Y-axis direction). The purpose of providing the heating wires 2 in the up-down direction of the vehicle is to avoid overlapping of the heating wires 2 on a contour of a horizontal feature or the like in a field of view of a passenger of the vehicle. In other words, if the heating wires 2 are provided in the width direction of the vehicle (the X-axis direction), the heating wires 2 might be overlapped on the contour of a horizontal feature or the like in the field of view of a passenger of the vehicle to affect the field of view of the passenger. In particular, in the case in which the heating wires 2 are caused to function as the deicer, the heating wires 2 are thick and have great influence on the range of view of the window glass 1 for vehicle. In order to prevent such an influence from being exerted, the heating wires 2 of the window glass 1 for vehicle to be used particularly as a windshield are provided in the up-down direction of the vehicle.

A case in which a communication instrument is arranged in the room of the vehicle on which the window glass 1 for vehicle for comparison having these heating wires 2 is mounted and in which an electric wave transmitted from the communication instrument transmits through the window glass 1 for vehicle will be studied. Note that although an electric wave transmitted from the communication instrument will be studied here, the same applies to an electric wave received by the communication instrument.

FIG. 2A shows a case in which the electric wave transmitted from the communication instrument is a vertically polarized wave. The electric wave has an electric field in the vertical direction, which is equal to the direction (the Y-axis direction) in which the heating wires 2 extend. Thus, the vertically polarized electric wave is absorbed into the heating wires 2, and the electric field of the electric wave that propagates to the outside of the window glass 1 for vehicle significantly decreases.

FIG. 2B shows a case in which the electric wave transmitted from the communication instrument is a horizontally polarized wave. The electric wave has an electric field in the horizontal direction, which is perpendicular to the direction (the Y-axis direction) in which the heating wires 2 extend. Thus, the horizontally polarized electric wave transmits while being hardly absorbed into the heating wires 2. Thus, the electric field of the electric wave that propagates to the outside of the window glass 1 for vehicle hardly decreases.

FIG. 2C shows a case in which the electric wave transmitted from the communication instrument is a circularly polarized wave. A perpendicular component is absorbed into the heating wires 2 because the electric field of the electric wave rotates relative to the X −Y plane, whereas a horizontal component transmits while being hardly absorbed into the heating wires 2. Thus, in the case of the circularly polarized electric wave, the electric field of the electric wave that propagates to the outside of the window glass 1 for vehicle decreases to some degree.

As described above, the horizontally polarized electric wave (FIG. 2B) transmits while being hardly absorbed into the heating wires 2, whereas a large proportion of the vertically polarized electric wave is absorbed into the heating wires 2, resulting in very low transmittance. The circularly polarized electric wave is absorbed into the heating wires 2 to some degree and is thus lower in transmittance than the horizontally polarized electric wave.

In general, an electric wave transmitted/received by a communication instrument mounted on a vehicle is a vertically polarized wave in many cases. In general, an electric wave transmitted/received by a communication instrument mounted on a vehicle is a circularly polarized wave in some cases, but rarely is a horizontally polarized wave.

An electric wave transmitted/received by the communication instrument 20 provided for the vehicle 10 mounted on the window glass 100 for vehicle of the present embodiment may be a vertically polarized wave or circularly polarized wave. Hereinafter, a mode in which the communication instrument 20 sends and receives a vertically polarized electric wave will be described as an example. Hereinafter, the window glass 100 for vehicle that can satisfy both of effective transmittivity of an electric wave and uniform heat generation distributions will be described.

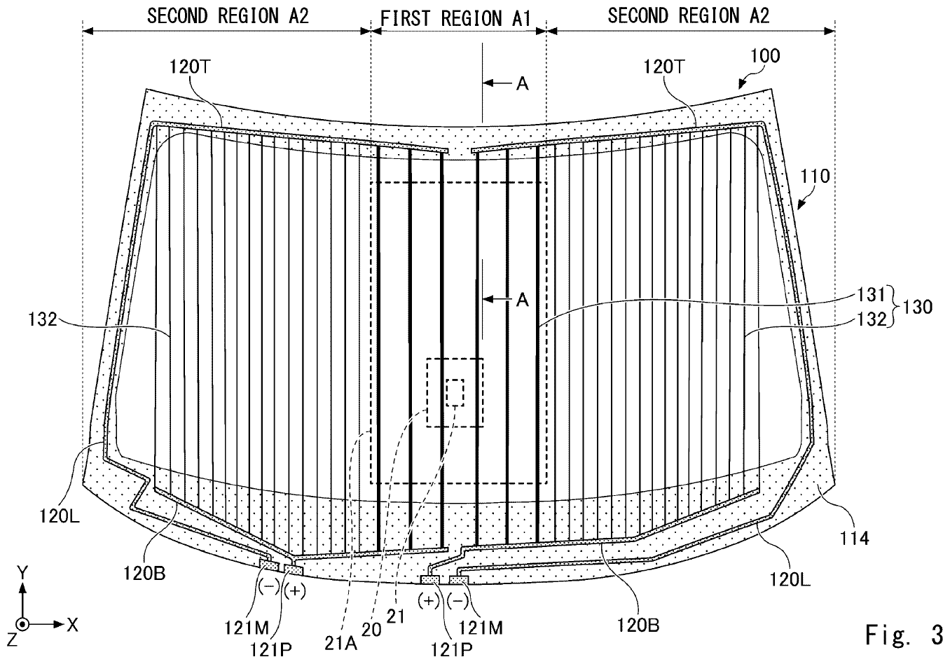

The X-Y-Z coordinate system which is the orthogonal coordinate system is used in FIG. 3 and subsequent drawings similarly to FIGS. 2A-2C. The X-axis direction, the Y-axis direction, and the Z-axis direction represent the direction parallel to the X-axis, the direction parallel to the Y-axis, and the direction parallel to the Z-axis, respectively. The X-axis direction, the Y-axis direction, and the Z-axis direction are orthogonal to one another. The X-Y plane, the Y-Z plane, and the Z-X plane represent an imaginary plane parallel to the X-axis direction and the Y-axis direction, an imaginary plane parallel to the Y-axis direction and the Z-axis direction, and an imaginary plane parallel to the Z-axis direction and the X-axis direction, respectively. A plan view indicates a view in the X-Y plane.

In the present embodiment, the X-axis direction, the Y-axis direction, and the Z-axis direction represent a right-left direction (lateral direction) of the window glass 100 for vehicle, the up-down direction (vertical direction) of the window glass 100 for vehicle, and a direction (normal direction) perpendicular to the surface of the window glass 100 for vehicle, respectively. The X-axis direction, the Y-axis direction, and the Z-axis direction are orthogonal to one another.

### Overall Configuration of Window Glass 100 for Vehicle

FIG. 3 is a view showing an example of the configuration of the window glass 100 for vehicle in a plan view. The window glass 100 for vehicle includes a laminated glass 110, upper edge bus bars 120T, lower edge bus bars 120B, lead bus bars 120L, and heating wires 130. There are two each of the upper edge bus bars 120T, the lower edge bus bars 120B, and the lead bus bars 120L. The heating wires 130 are an example of a heating section and may function as a deicer that efficiently melts ice or snow adhering to the outermost surface of the window glass 100 for vehicle. A value of electric current to be flowed to the heating wires 130 that function as the deicer may be higher than a value of electric current to be flowed to a conductor that causes the heating wires 130 to function as a defogger that removes haze (water drops) on the surface of the window glass 100 for vehicle.

FIG. 3 shows a state in which the window glass 100 for vehicle is seen from outside the room of the vehicle body 11. FIG. 3 shows the upper edge bus bars 120T, the lower edge bus bars 120B, the lead bus bars 120L, and the heating wires 130 transparently. FIG. 3 also shows the communication instrument 20 in addition to the window glass 100 for vehicle. The communication instrument 20 is provided in a central portion in the right-left direction of the upper portion of the dashboard 12 of the window glass 100 for vehicle in a plan view. The electric wave propagation region 21A shown in FIG. 3 is a portion in which the electric wave propagation region 21A in FIG. 1B and the window glass 100 for vehicle intersect with each other and represents a transmission region in which an electric wave transmits through the window glass 100 for vehicle.

Hereinafter, description will be given assuming that the laminated glass 110 has a first region A1 and second regions A2. The first region A1 is a region in which the communication instrument 20 is positioned in the width direction of the vehicle body 11, and in FIG. 3, is a region in which the electric wave propagation region 21A (transmission region) is present in the X-direction in the laminated glass 110 as an example. The second regions A2 are regions other than the first region A1 in the X-direction in the laminated glass 110. Hereinafter, a mode in which the first region A1 is positioned in the central portion in the width direction of the vehicle body 11 and in which the two second regions A2 are positioned on both sides of the first region A1 will be described as an example, but the first region A1 may be positioned at an end in the width direction of the vehicle body 11. In this case, a single second region A2 may be provided.

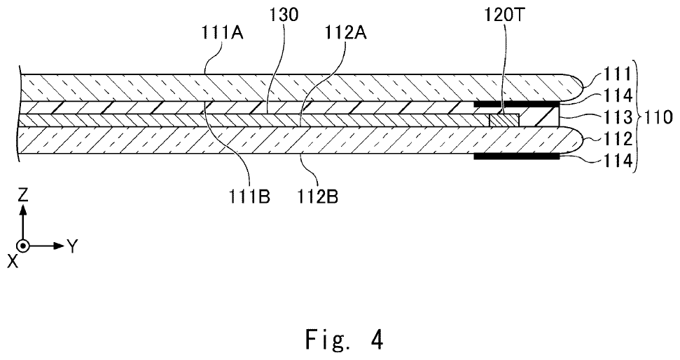

FIG. 4 is a view showing an example of the configuration of the window glass 100 for vehicle in FIG. 3 taken along a line indicated by arrows A-A. FIG. 4 shows the window frame 11A of the vehicle body 11 in addition to the window glass 100 for vehicle. The window frame 11A is formed in a flange shape along an outer edge of the window glass 100 for vehicle. The outer edge of the window glass 100 for vehicle is an edge outside the window glass 100 for vehicle in a plan view. The outer edge of the window glass 100 for vehicle is an outer edge of the laminated glass 110.

In FIG. 3 and FIG. 4, the X-axis direction is the right-left direction of the vehicle 10, and the Y-axis direction is the up-down direction of the window glass 100 for vehicle. In a state in which the window glass 100 for vehicle is attached to the window frame 11A formed in the vehicle body 11, the +Z-axis direction side of the window glass 100 for vehicle is outside the room of the vehicle body 11, and the −Z-axis direction side of the window glass 100 for vehicle is inside the room of the vehicle body 11.

### Laminated Glass 110

The laminated glass 110 has a glass plate 111, a glass plate 112, an intermediate film 113, and ceramic layers 114. The laminated glass 110 is formed by bonding the glass plate 111 provided for the vehicle body 11 outside the room and the glass plate 112 provided for the vehicle body 11 inside the room with the interposition of the intermediate film 113 arranged between the glass plates 111 and 112 as shown in FIG. 4. The ceramic layers 114 are provided on a main surface 111B of the glass plate 111 inside the room and a main surface 112B of the glass plate 112 inside the room. The upper edge bus bars 120T, the lower edge bus bars 120B, the lead bus bars 120L, and the heating wires 130 are provided on the main surface 112B of the glass plate 112 inside the room. The ceramic layer 114 is an example of a shield layer. The two ceramic layers 114 have an equal shape in a plan view as an example.

### Glass Plates 111 and 112

The glass plate 111 is an example of a first glass plate, and the glass plate 112 is an example of a second glass plate. The laminated glass 110 is bonded to the window frame of the vehicle body 11 with an adhesive such as a urethane resin or the like. Note that although the mode in which the window glass 100 for vehicle is the windshield (front window) to be attached to the front portion of the vehicle 10 will be described here, the laminated glass 110 may be attached to a door of the vehicle 10, for example, and may be provided to be slidable over the vehicle body 11.

The glass plates 111 and 112 are transparent, plate-like glass plates. The glass plate 111 has a main surface 111A outside the room and a main surface 111B inside the room. The main surface 111A is an example of a first main surface, and the main surface 111B inside the room is an example of a second main surface. The glass plate 112 has a main surface 112A outside the room and a main surface 112B inside the room. The main surface 112A is an example of a third main surface, and the main surface 112B inside the room is an example of a fourth main surface.

The glass plates 111 and 112 may be inorganic glass or organic glass. Soda-lime glass, aluminosilicate glass, borosilicate glass, alkali-free glass, quartz glass, or the like, for example, is used as the inorganic glass without particular restrictions. Among them, soda-lime glass is particularly preferable from the viewpoint of manufacturing cost and formability. The method for forming the glass plates 111 and 112 is not particularly limited. In the case of the inorganic glass, for example, a glass plate formed by a float process or the like is preferable.

In the case in which the glass plates 111 and 112 are inorganic glass, the glass plates 111 and 112 may be either non-tempered glass or tempered glass. The non-tempered glass is obtained by forming molten glass into a plate shape, followed by slow cooling. The tempered glass is obtained by making a compressive stress layer on a surface of non-tempered glass, and may either be air-cooled tempered glass or chemically tempered glass.

In a case in which tempered glass is physically tempered glass (for example, air-cooled tempered glass), a glass surface may be tempered by producing a compressive stress layer on the glass surface utilizing a temperature difference between the glass surface and the inside of glass by an operation other than slow cooling, such as rapid cooling of a glass plate evenly heated in bending from a temperature around a softening point. In a case in which tempered glass is chemically tempered glass, the glass surface may be tempered by, after bending, producing a compressive stress on the glass surface by an ion exchange method or the like. Glass that absorbs ultraviolet light or infrared light may be used for the glass plates 111 and 112. The glass plates 111 and 112 are preferably transparent, but may be glass plates colored to such a degree that transparency is not impaired.

The laminated glass 110 may have such a curved shape as to protrude outside the room when attached to the vehicle 10. The laminated glass 110 may have a single-bent shape that is bent only in one direction or may have a multiple-bent shape that is bent in two directions (for example, the up-down direction and the right-left direction orthogonal to the up-down direction when the laminated glass 110 is attached to the vehicle 10). Gravity bending, press bending, roller bending, or the like is used for bending the laminated glass 110.

In a case in which the laminated glass 110 is bent to have a predetermined curvature, the laminated glass 110 may have a radius of curvature of 1000 mm or more and 100000 mm or less.

In the case in which the laminated glass 110 is attached to the vehicle 10, a thickness of the glass plate 111 positioned outside the room and a thickness of the glass plate 112 positioned inside the room may be the same or may be different. The thickness of the glass plate 111 preferably is 1.0 mm or more and 3.0 mm or less. When the thickness of the glass plate 111 is 1.0 mm or more, the strength such as tolerance to stone chips is sufficient, and when the thickness of the glass plate 111 is 3.0 mm or less, the mass of the laminated glass 110 is not excessively large, which is preferable in terms of fuel consumption of the vehicle 10. The thickness of the glass plate 112 preferably is 0.3 mm or more and 2.3 mm or less. When the plate thickness of the glass plate 112 is 0.3 mm or more, good handling efficiency is obtained, and when the plate thickness of the glass plate 112 is 2.3 mm or less, the mass is not excessively large. When the thicknesses of the glass plates 111 and 112 are each 1.8 mm or less, both of weight reduction and sound insulation of the laminated glass 110 can be satisfied, which is preferable. Note that when the thickness of the glass plate 112 is 1.0 mm or less, the glass plate 112 may be chemically tempered glass. In the case in which the glass plate 112 is chemically tempered glass, the glass surface preferably has a compressive stress value of 300 MPa or more, and the compressive stress layer preferably has a depth of 2 μm or more. In the case in which the glass plates 111, 112 are organic glass, transparent resin such as polycarbonate or acrylic resin (for example, polymethylmethacrylate) can be used as the material for the organic glass.

### Intermediate Film 113

The intermediate film 113 is dielectric and is a transparent or semi-transparent dielectric body interposed between the glass plates 111 and 112 as shown in FIG. 4. The glass plates 111 and 112 are bonded by the intermediate film 113. Examples of the material for the intermediate film 113 can include thermoplastic polyvinyl butyral (PVB), ethylene-vinyl acetate copolymer (EVA), and the like. The intermediate film 113 may be transparent or may be colored. In addition, the intermediate film 113 may be composed of a film of two or more layers.

The upper edge bus bars 120T, the lower edge bus bars 120B, and the lead bus bars 120L are provided in a portion in which the ceramic layers 114 are present in a plan view. Thus, the intermediate film 113 is provided in a portion which will be described below.

The intermediate film 113 is arranged between the glass plates 111 and 112 as an example in a portion in which the ceramic layers 114, the upper edge bus bars 120T, the lower edge bus bars 120B, the lead bus bars 120L, and the heating wires 130 are not present in a plan view.

The intermediate film 113 is arranged between the glass plate 111 and the heating wires 130 as an example in a portion in which the ceramic layers 114 are not present and in which the heating wires 130 are present in a plan view.

The intermediate film 113 is arranged between the ceramic layers 114 and the upper edge bus bars 120T, the lower edge bus bars 120B or the lead bus bars 120L as an example in a portion in which the ceramic layers 114 are present and in which the upper edge bus bars 120T, the lower edge bus bars 120B, or the lead bus bars 120L are present in a plan view.

The intermediate film 113 is arranged between the glass plate 111 and the heating wires 130 as an example in a portion in which the ceramic layers 114 are present and in which the heating wires 130 are present in a plan view.

The intermediate film 113 is arranged between the ceramic layers 114 and the glass plate 112 as an example in a portion in which the ceramic layers 114 are present and in which the upper edge bus bars 120T, the lower edge bus bars 120B, the lead bus bars 120L, and the heating wires 130 are not present in a plan view.

### Ceramic Layers 114

The ceramic layers 114 are fired bodies of a dark ceramic paste as an example, and are made by applying a ceramic color paste including fusible glass frit containing a black pigment, followed by firing. The ceramic layers 114 are made for preventing the adhesive from becoming deteriorated due to ultraviolet light in the state in which the window glass 100 for vehicle is bonded to the vehicle 10, and are made for improving the appearance such that a connecting portion between the window glass 100 for vehicle and the vehicle body 11 is not visible from outside the vehicle 10. The ceramic layers 114 are provided in a circumferential edge portion of the laminated glass 110 in a plan view. The circumferential edge portion of the laminated glass 110 is a circumferential portion of the laminated glass 110 extending along the outer edge slightly inside the outer edge of the laminated glass 110 in a plan view. The circumferential edge portion of the laminated glass 110 corresponds to circumferential edge portions of the glass plates 111 and 112, and the outer edge of the laminated glass 110 corresponds to the outer edges of the glass plates 111 and 112.

The ceramic layers 114 are each provided on the circumferential edge portions of the main surfaces 111B and 112B of the glass plates 111 and 112 inside the room. As an example, the ceramic layer 114 provided on the glass plate 111 and the ceramic layer 114 provided on the glass plate 112 have an equal shape in a plan view and also have an equal position in a plan view. Note that the ceramic layer 114 may be provided only on the main surface 111B of the glass plate 111 inside the room, or may be provided only on the main surface 112B of the glass plate 112 inside the room.

### Upper Edge Bus Bars 120T

The upper edge bus bars 120T are bus bars extending along the upper edge of the laminated glass 110. The upper edge of the laminated glass 110 is equivalent to an edge extending in the X-axis direction on the +Y-axis direction side in the outer edge of the laminated glass 110. The upper edge bus bars 120T are provided between the glass plates 111 and 112 in a region overlapped on the ceramic layers 114 in a plan view. The upper edge bus bars 120T are provided along the upper edge of the laminated glass 110 across the first region A1 and the second regions A2 in the X-axis direction.

The upper edge bus bars 120T are divided to the right and left at the center in the X-axis direction of the window glass 100 for vehicle. The lead bus bar 120L provided on the left side of the window glass 100 for vehicle is connected to a left end of the upper edge bus bar 120T on the left side. The lead bus bar 120L provided on the right side of the window glass 100 for vehicle is connected to a right end of the upper edge bus bar 120T on the right side.

Note that the upper edge bus bars 120T may be a single upper edge bus bar 120T extending between the left end side and the right end side of the window glass 100 for vehicle without being divided to the right and left at the center in the X-axis direction of the window glass 100 for vehicle. In this case, a single lead bus bar 120L may be connected to either one of both ends of the single upper edge bus bar 120T.

### Lower Edge Bus Bars 120B

The lower edge bus bars 120B are bus bars extending along the lower edge of the laminated glass 110. The lower edge of the laminated glass 110 is equivalent to an edge extending in the X-axis direction on the −Y-axis direction side in the outer edge of the laminated glass 110. The lower edge bus bars 120B are provided between the glass plates 111 and 112 in a region overlapped on the ceramic layers 114 in a plan view. The lower edge bus bars 120B are provided across the first region A1 and the second regions A2 in the X-axis direction along the lower edge of the laminated glass 110.

The lower edge bus bars 120B are divided to the right and left at the center in the X-axis direction of the window glass 100 for vehicle. Positive (+) terminals 121P are connected to the right and left lower edge bus bars 120B, respectively. The terminals 121P are exposed to the outside of the laminated glass 110 from a lateral surface of the intermediate film 113, and are connected to a positive terminal of a power supply such as a battery of the vehicle 10 or the like via a switch or the like.

Note that the lower edge bus bars 120B may be a single lower edge bus bar 120B extending between the left end side and the right end side of the window glass 100 for vehicle without being divided to the right and left at the center in the X-axis direction of the window glass 100 for vehicle. In this case, a single terminal 121P may be connected to the single lower edge bus bar 120B.

### Lead Bus Bars 120L

The lead bus bars 120L are each provided on the +X-axis direction side (left side) and the −X-axis direction side (right side) on the outer edge of the window glass 100 for vehicle, and are connected to the two upper edge bus bars 120T divided to the right and left at the center in the X-axis direction of the window glass 100 for vehicle. The two lead bus bars 120L extend to the lower edge side of the window glass 100 for vehicle, and negative (−) terminals 121M are connected to ends on the lower edge side. The terminals 121M are exposed to the outside of the laminated glass 110 from the lateral surface of the intermediate film 113, and are connected to a negative terminal of the power supply such as the battery of the vehicle 10 via a switch or the like.

### Heating Wires 130

The heating wires 130 have first heating wires 131 and second heating wires 132. The first heating wires 131 and the second heating wires 132 are connected to the upper edge bus bars 120T and the lower edge bus bars 120B, and extend in the Y-axis direction between the upper edge bus bars 120T and the lower edge bus bars 120B.

The first heating wires 131 and the second heating wires 132 are round conductive wires as an example, and are implemented by tungsten wires as an example. Although extending in the Y-axis direction while curving sinusoidally with respect to the Y-axis direction within the X-Y plane, the first heating wires 131 and the second heating wires 132 are shown linearly in FIG. 3 because of a very small width of deflection equivalent to an amplitude of a sinusoidal wave.

The first heating wires 131 are provided in plural in the first region A1, and are connected between the upper edge bus bars 120T and the lower edge bus bars 120B. A first pitch between the first heating wires 131 in the width direction of the vehicle body 11 is wider than a second pitch between the second heating wires 132 in the width direction of the vehicle body 11. As an example, the first pitch between the first heating wires 131 preferably is 3 mm to 8 mm, and more preferably is 3.5 mm to 5 mm as an example. Note that the second pitch between the second heating wires 132 is 2 mm as an example. Note that the pitch between adjacent ones of the first heating wires 131 preferably is the same between the upper edge bus bars 120T and the lower edge bus bars 120B.

The first region A1 is a region in which the communication instrument 20 is present, and an electric wave transmitted/received by the communication instrument 20 transmits through the window glass 100 for vehicle. Thus, a configuration in which a vertically polarized electric wave is less likely to be absorbed into the first heating wires 131 is achieved by making the first pitch between the first heating wires 131 wider than the second pitch between the second heating wires 132. Provision of the first heating wires 131 in the first region A1 increases transmittivity of an electric wave transmitted/received by the communication instrument 20 through the window glass 100 for vehicle.

The first heating wires 131 are thicker than the second heating wires 132. As an example, the first heating wires 131 preferably have a diameter of 0.025 mm or more and 0.03 mm or less. The second heating wires 132 preferably have a diameter of 0.02 mm or more and 0.025 mm or less. The first pitch between the first heating wires 131 in the X-axis direction in the first region A1 is wider than the second pitch between the second heating wires 132 in the X-axis direction in the second regions A2. Thus, the first heating wires 131 are made thicker than the second heating wires 132 such that a heat generation distribution equal to a heat generation distribution in the second regions A2 can be obtained. The heat generation distribution indicates including both of the level of a heat generation temperature itself and a planar distribution of a region in which heat is generated.

An amount of heat generation of each of the first heating wires 131 is made larger than an amount of heat generation of each of the second heating wires 132 by making it easier for electrical current to flow into the first heating wires 131 than the second heating wires 132, thereby equalizing the heat generation distribution of the laminated glass 110 in the first region A1 to the heat generation distribution of the laminated glass 110 in the second regions A2. In this manner, a sufficient function as a deicer that efficiently melts ice or snow adhering to the outermost surface of the window glass 100 for vehicle or a defogger that removes haze (water drops) on the surface of the window glass 100 for vehicle is ensured in the first region A1.

Note that a mode in which the first heating wires 131 are thicker than the second heating wires 132 will be described here. However, the first heating wires 131 and the second heating wires 132 may be equal in diameter in a case in which the sufficient function as the deicer or the defogger is obtained in the first region A1 even if the first heating wires 131 and the second heating wires 132 are equal in diameter.

The second heating wires 132 are provided in plural in the second regions A2 and are connected between the upper edge bus bars 120T and the lower edge bus bars 120B. The second pitch between the second heating wires 132 in the width direction of the vehicle body 11 is 2 mm as an example. The second heating wires 132 are similar to the heating wires 2 of the window glass 1 for vehicle for comparison (see FIG. 2A to FIG. 2C) and ensure a sufficient function as the deicer that efficiently melts ice or snow adhering to the outermost surface of the window glass 100 for vehicle or the defogger that removes haze (water drops) on the surface of the window glass 100 for vehicle in the second regions A2. Note that the pitch between adjacent ones of the second heating wires 132 preferably is the same between the upper edge bus bars 120T and the lower edge bus bars 120B. The pitch between the first heat transfer line 131 and the second heat transfer line 132 adjacent to each other may be the same as the pitch between adjacent ones of the first heating wires 131, or may be the same as the pitch between adjacent ones of the second heating wires 132.

The first heating wires 131 and the second heating wires 132 as described above are supplied with the same amount of electrical power because of being connected to the upper edge bus bars 120T and the lower edge bus bars 120B. A larger amount of electrical current flows to the first heating wires 131 than to the second heating wires 132 because the first heating wires 131 are thicker than the second heating wires 132. Thus, the amount of heat generation of each of the first heating wires 131 is larger than the amount of heat generation of each of the second heating wires 132.

In this manner, the heat generation distributions in the first region A1 and the second regions A2 can be equalized, and transmittivity of an electric wave transmitted/received by the communication instrument 20 can be increased in the first region A1 by making the first pitch between the first heating wires 131 wider than the second pitch between the second heating wires 132.

### Simulation Result of Transmitted Electrical Power

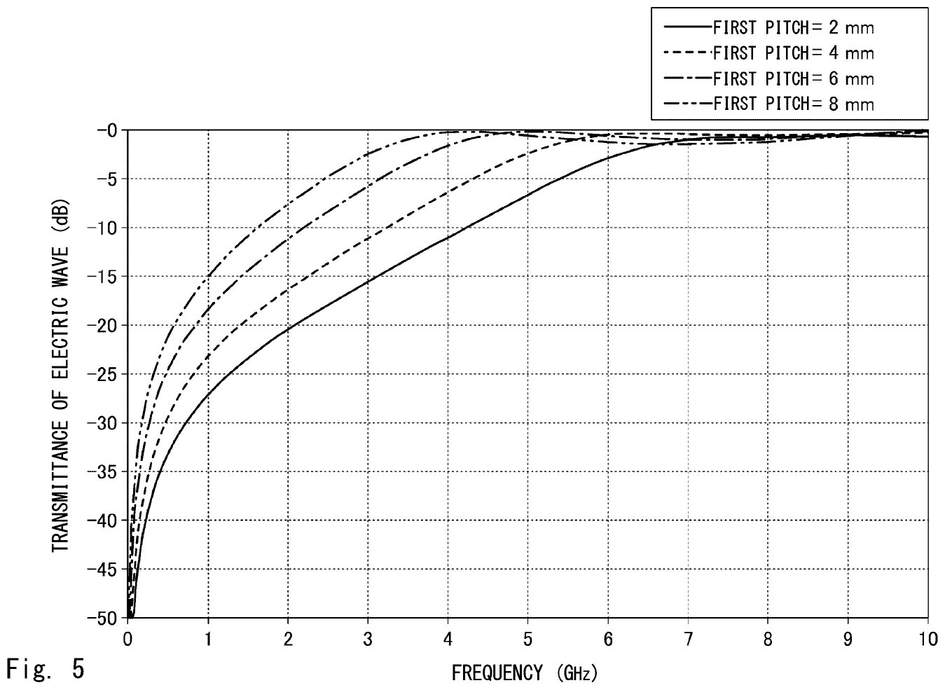

FIG. 5 is a view showing an example of a simulation result of transmitted electrical power. As an example, simulations were performed with the first pitch between the first heating wires 131 in the width direction of the vehicle body 11 set at 2 mm, 4 mm, 6 mm, and 8 mm under a condition that the diameter of the first heating wires 131 was set at 0.025 mm, the diameter of the second heating wires 132 was set at 0.02 mm, and the second pitch between the second heating wires 132 in the width direction of the vehicle body 11 was set at 2 mm. Note that a result obtained in the case in which the first pitch was 2 mm is a result for reference since the first pitch is equal to the second pitch.

In FIG. 5, the horizontal axis represents frequency (GHz), and the vertical axis represents transmittance (dB) of an electric wave. The transmittance of an electric wave represents, by a relative value, electrical power (transmitted electrical power) of an electric wave transmitted through the window glass 100 for vehicle with respect to electrical power transmitted from the communication instrument 20.

When simulations were performed with the first pitch set at 2 mm, 4 mm, 6 mm, and 8 mm, transmittance at any of the first pitches was equal at a frequency of 7 GHz or more, and transmitted electrical power hardly decreased with respect to transmitted electrical power.

Under a condition that the frequency was 6 GHz, transmitted electrical power with the first pitch set at 4 mm, 6 mm, and 8 mm was improved relative to transmitted electrical power with the first pitch set at 2 mm. Thus, it has been found that sufficient transmitted electrical power is obtained in the band of 5.9 GHz or 5.8 GHz that may be utilized for V2X if the first pitch is 4 mm or more.

Under a condition that the frequency was 6 GHz or less, transmitted electrical power with the first pitch set at 4 mm, 6 mm, and 8 mm was also improved relative to transmitted electrical power with the first pitch set at 2 mm. A tendency that the degree of decrease in transmitted electrical power diminished as the first pitch was larger was exhibited.

It has also been found that when the first pitch is 6 mm or 8 mm, transmittivity of an electric wave is effective, but the heat generation distribution decreases. Thus, it is preferable that an electric wave transmitted/received by the communication instrument 20 should have a frequency of 6 GHz or less and that the first pitch should be 4 mm or less. From these points of view, the pitch between the heating wires in the X-axis direction is set at 2.5 mm and 3.6 mm in simulations of the amount of heat generation which will be described next.

### Simulation Result of the Amount of Heat Generation

Simulations of the amount of heat generation were also performed. The amount of heat generation is in proportion to the density of electrical power supplied to the heating wires of the laminated glass. Thus, an average value of the density of electrical power (hereinafter, an average electrical power density) in the heating wires was calculated to analyze the tendencies in the amount of heat generation in laminated glasses for simulation.

In the laminated glasses for simulation, the pitch between all of the heating wires 130 in the X-axis direction was equalized in the first region A1 and the second regions A2 of the laminated glass 110 of the embodiment. The average electrical power density was calculated for three types of laminated glasses for simulation different in diameter of and pitch between the heating wires. The three types of laminated glasses for simulation are indicated below.

In the first laminated glass, the pitch between the heating wires in the X-axis direction is 2.5 mm, and the diameter of the heating wires is 0.025 mm (25 μm). The first laminated glass is equivalent to a laminated glass, the whole of which is the second region A2 of the laminated glass 110 of the embodiment.

In the second laminated glass, the pitch between the heating wires in the X-axis direction is 3.6 mm, and the diameter of the heating wires is 0.025 mm (25 μm). In other words, the second laminated glass is obtained by widening the pitch in the X-axis direction between the heating wires of the first laminated glass.

In the third laminated glass, the pitch between the heating wires in the X-axis direction is 3.6 mm, and the diameter of the heating wires is 0.03 mm (30 μm). In other words, the third laminated glass is obtained by thickening the heating wires of the second laminated glass. The third laminated glass is equivalent to a laminated glass, the whole of which is the first region A1 of the laminated glass 110 of the embodiment.

For these three types of laminated glasses for simulation, the average electrical power densities in the heating wires in the left half and the right half were calculated, and the following result was obtained. The left half of the laminated glass is a portion in which the heating wires are provided on the +X-direction side relative to the center of the width in the X-axis direction of the laminated glass. The right half of the laminated glass is a portion in which the heating wires are provided on the −X-direction side relative to the center of the width in the X-axis direction of the laminated glass.

The average electrical power density in the heating wires of the first laminated glass was 650 (W/m²) in the left half and 662 (W/m²) in the right half. The average electrical power density in the heating wires of the second laminated glass was 469 (W/m²) in the left half and 470 (W/m²) in the right half. The average electrical power density of the second laminated glass having the configuration in which the pitch in the X-axis direction was made wider than in the first laminated glass without changing the diameter of the heating wires decreased by about 30% relative to the average electrical power density in the heating wires of the first laminated glass.

The average electrical power density in the heating wires of the third laminated glass was 630 (W/m²) in the left half and 641 (W/m²) in the right half. The average electrical power density of the third laminated glass having the configuration in which the heating wires were made thicker and the pitch in the X-axis direction was made wider than in the first laminated glass decreased by about 3% relative to the average electrical power density in the heating wires of the first laminated glass, but values recognized as substantially equal were obtained.

In the laminated glass 110 of the window glass 100 for vehicle of the embodiment, the configuration in the first region A1 is equivalent to the third laminated glass for simulation, and the configuration in the second regions A2 is equivalent to the first laminated glass for simulation.

Thus, it was confirmed that an average electrical power density similar to an average electrical power density of the first laminated glass for simulation was also obtained in the first region A1 in the laminated glass 110 of the window glass 100 for vehicle of the embodiment. In other words, it was confirmed that the laminated glass 110 of the window glass 100 for vehicle of the embodiment was able to satisfy both of effective transmittivity of an electric wave in the first region A1 in which the communication instrument 20 was positioned in the width direction of the vehicle body 11 and heat generation distributions.

### Effects

The window glass 100 for vehicle includes the laminated glass 110, the upper edge bus bars 120T, the lower edge bus bars 120B, and the heating wires 130. The laminated glass 110 has the glass plate 111 having the main surface 111A and the main surface 111B, the glass plate 112 having the main surface 112A and the main surface 112B, and the intermediate film provided between the main surface 111B and the main surface 112A, and is provided in the opening of the vehicle body 11. The upper edge bus bars 120T are provided between the main surface 111B and the main surface 112A along the upper edge of the laminated glass 110. The lower edge bus bars 120B are provided between the main surface 111B and the main surface 112A along the lower edge of the laminated glass 110. The heating wires 130 are provided between the main surface 111B and the main surface 112A and are connected between the upper edge bus bars 120T and the lower edge bus bars 120B. The laminated glass 110 has the first region A1 in which the communication instrument 20 is positioned in the width direction of the vehicle body 11 and the second regions A2 other than the first region A1. The heating wires 130 have the first heating wires 131 provided in the first region A1 and connected between the upper edge bus bars 120T and the lower edge bus bars 120B and the second heating wires 132 provided in the second regions A2 and connected between the upper edge bus bars 120T and the lower edge bus bars 120B. The first pitch between the first heating wires 131 in the width direction of the vehicle body 11 is wider than the second pitch between the second heating wires 132 in the width direction of the vehicle body 11.

Thus, effective transmittivity of an electric wave can be ensured in the first region A1, and uniform heat generation distributions can be obtained in the first region A1 and the second regions A2.

Therefore, the window glass 100 for vehicle that can satisfy both of effective transmittivity of an electric wave and uniform heat generation distributions can be provided.

Since the first heating wires 131 are thicker than the second heating wires 132, a larger amount of electrical current flows to the first heating wires 131. Thus, more uniform heat generation distributions are obtained in the first region A1 and the second regions A2 with effective transmittivity of an electric wave ensured in the first region A1.

Since the first region A1 is positioned in the central portion or at an end in the width direction of the vehicle body 11, both of effective transmittivity of an electric wave in the first region A1 and uniform heat generation distributions in the first region A1 and the second regions A2 can be satisfied in correspondence to the configuration in which the communication instrument 20 is arranged in the central portion or at an end in the width direction of the vehicle body 11.

The first pitch and the second pitch are constant between the upper edge bus bars 120T and the lower edge bus bars 120B. Thus, effective transmittivity of an electric wave can be ensured in the first region A1 between the upper edge bus bars 120T and the lower edge bus bars 120B, and uniform heat generation distributions can be obtained in the first region A1 and the second regions A2.

The frequency of an electric wave transmitted/received by the communication instrument 20 is 6 GHz or less, and the first pitch is 4 mm or less. Thus, for an electric wave of 6 GHz or less, effective transmittivity of an electric wave can be ensured in the first region A1 with the first heating wires 131 having the first pitch of 4 mm or less, and uniform heat generation distributions can be obtained in the first region A1 and the second regions A2.

Since an electric wave transmitted/received by the communication instrument 20 is a vertically polarized wave or circularly polarized wave, transmittivity of an electric wave can be reliably improved by widening the first pitch between the first heating wires 131 extending in the up-down direction (the Y-axis direction) between the upper edge bus bars 120T and the lower edge bus bars 120B.

### First Modification

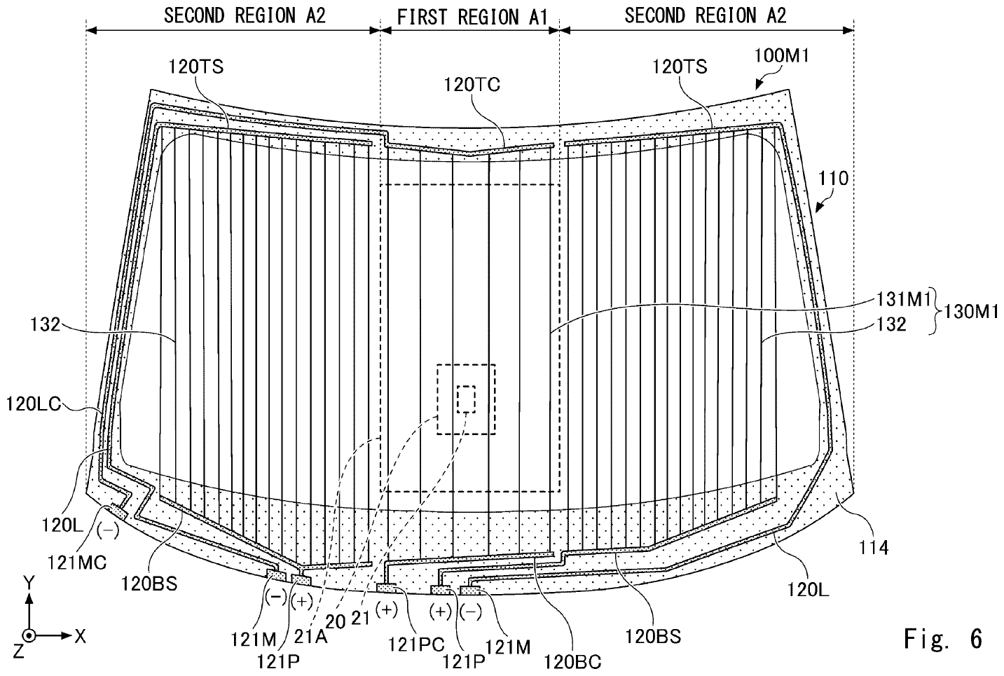

FIG. 6 is a view showing an example of a configuration of a window glass 100M1 for vehicle of a first modification of the embodiment in a plan view. The window glass 100M1 for vehicle includes the laminated glass 110, an upper edge bus bar 120TC, upper edge bus bars 120TS, a lower edge bus bar 120BC, lower edge bus bars 120BS, the lead bus bar 120L, a lead bus bar 120LC, and heating wires 130M1. The upper edge bus bar 120TC is an example of a first upper edge bus bar, and the upper edge bus bar 120TS is an example of a second upper edge bus bar. The lower edge bus bar 120BC is an example of a first lower edge bus bar, and the lower edge bus bar 120BS is an example of a second lower edge bus bar.

The window glass 100M1 for vehicle has a configuration in which each of the upper edge bus bars 120TS and each of the lower edge bus bar 120BS equivalent to the upper edge bus bars 120T and the lower edge bus bars 120B in the window glass 100 for vehicle are arranged in the two second regions A2 and in which the upper edge bus bar 120TC and the lower edge bus bar 120BC are added into the first region A1. In other words, the upper edge bus bars and lower edge bus bars are divided into the first region A1 and the second regions A2. The lead bus bar 120LC is connected to the upper edge bus bar 120TC.

The heating wires 130M1 have first heating wires 131M1 arranged in the first region A1 and the second heating wires 132 arranged in the second regions A2, and the first heating wires 131M1 and the second heating wires 132 are equal in diameter. The first pitch between the first heating wires 131M1 in the X-axis direction is wider than the second pitch between the second heating wires 132 in the X-axis direction because the first pitch between the first heating wires 131M1 in the X-axis direction is equal to the first pitch between the first heating wires 131 in the X-axis direction shown in FIG. 3. The second heating wires 132 are identical to the second heating wires 132 shown in FIG. 3.

The lead bus bar 120LC is provided in the circumferential edge portion of the laminated glass 110 across the +Y-axis direction side of the upper edge bus bar 120TS on the −X-axis direction side and the −X-axis direction side of the lead bus bar 120L as an example. A negative (−) terminal 121MC is connected to the lead bus bar 120LC. The terminal 121MC is provided at an end in the vicinity of a corner of the laminated glass 110 on the −X-axis direction side and the −Y-direction side as an example. A positive (+) terminal 121PC is connected to the lower edge bus bar 120BC. The terminal 121PC is positioned at an end on the −Y-direction side in the central portion in the X-axis direction of the laminated glass 110. The terminals 121PC and 121MC are exposed to the outside of the laminated glass 110 from the lateral surface of the intermediate film 113, and are connected respectively to a positive terminal and a negative terminal of the power supply such as the battery of the vehicle 10 via a switch or the like.

In the window glass 100M1 for vehicle, direct electrical power supplied across the terminals 121PC and 121MC is larger than direct electrical power supplied across the terminals 121P and 121M. More specifically, a voltage value of direct electrical power supplied across the terminals 121PC and 121MC is higher than a voltage value of direct electrical power supplied across the terminals 121P and 121M. Thus, electrical power supplied to the first heating wires 131M1 in the first region A1 is larger than electrical power supplied to the second heating wires 132 in the second regions A2, and a larger amount of electrical current flows to the first heating wires 131M1 than to the second heating wires 132.

Since a larger amount of electrical current flows to the first heating wires 131M1 than to the second heating wires 132, the amount of heat generation of each of the first heating wires 131M1 is larger than the amount of heat generation of each of the second heating wires 132, and the heat generation distribution of the laminated glass 110 in the first region A1 can be equalized to the heat generation distribution of the laminated glass 110 in the second regions A2.

Such a configuration of the window glass 100M1 for vehicle can equalize the heat generation distributions in the first region A1 and the second regions A2, and can increase transmittivity of an electric wave transmitted/received by the communication instrument 20 in the first region A1 by making the first pitch between the first heating wires 131M1 wider than the second pitch between the second heating wires 132.

As described above, in the window glass 100M1 for vehicle, the upper edge bus bar 120T has the upper edge bus bar 120TC positioned in the first region A1 and the upper edge bus bars 120TS positioned in the second regions A2. The lower edge bus bar 120B has the lower edge bus bar 120BC positioned in the first region A1 and the lower edge bus bars 120BS positioned in the second regions A2. The first heating wires 131M1 are connected between the upper edge bus bar 120TC and the lower edge bus bar 120BC, and the second heating wires 132 are connected between the upper edge bus bars 120TS and the lower edge bus bars 120BS. Electrical power supplied to the first heating wires 131M1 via the upper edge bus bar 120TC and the lower edge bus bar 120BC is larger than electrical power supplied to the second heating wires 132 via the upper edge bus bars 120TS and the lower edge bus bars 120BS.

Thus, a larger amount of electrical current flows to the first heating wires 131 than to the second heating wires 132, and the amount of heat generation of the first heating wires 131M1 can be made larger than the amount of heat generation of the second heating wires 132, and more uniform heat generation distributions are obtained in the first region A1 and the second regions A2 with effective transmittivity of an electric wave ensured in the first region A1.

Therefore, the window glass 100M1 for vehicle that can satisfy both of effective transmittivity of an electric wave and more uniform heat generation distributions can be provided.

Note that the first heating wires 131M1 may be made thicker than the second heating wires 132 while making electrical power supplied to the first heating wires 131M1 in the first region A1 larger than electrical power supplied to the second heating wires 132 in the second regions A2 as described above. By making the first heating wires 131M1 in the first region A1 thicker, it becomes easier for electrical current to flow to the first heating wires 131M1, and electrical power supplied to the first heating wires 131M1 can be reduced as compared with the case in which the first heating wires 131M1 and the second heating wires 132 are equal in diameter. The first pitch between the first heating wires 131M1 in the X-axis direction can be made still wider.

### Second Modification

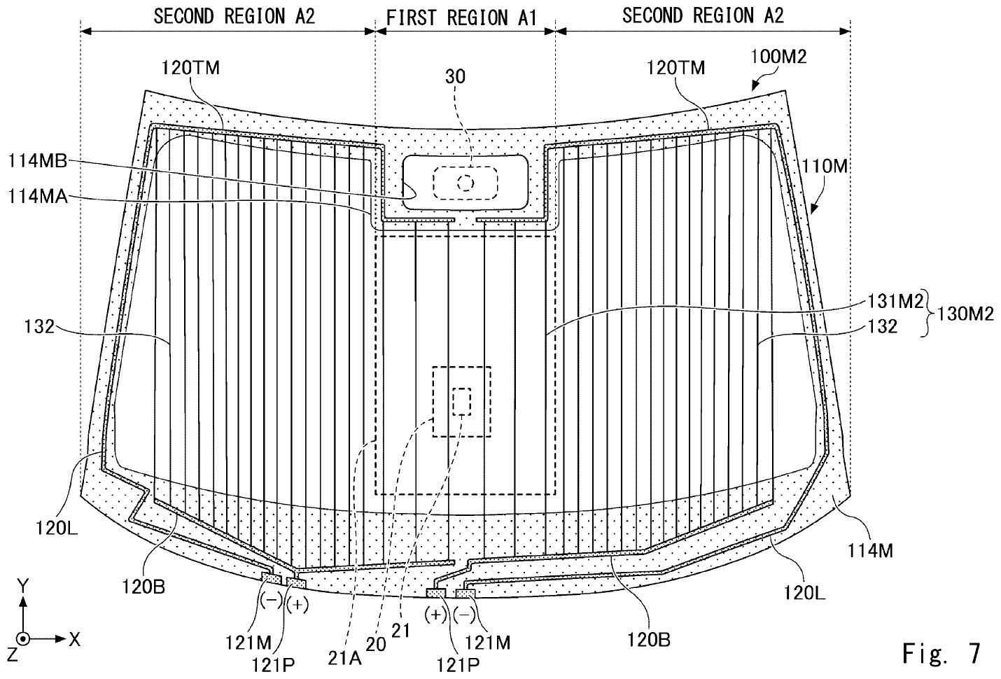

FIG. 7 is a view showing an example of a configuration of a window glass 100M2 for vehicle of a second modification of the embodiment in a plan view. The window glass 100M2 for vehicle includes a laminated glass 110M, upper edge bus bars 120TM, the lower edge bus bars 120B, the lead bus bars 120L, and heating wires 130M2. Of the upper edge bus bar 120TM, a portion positioned in the first region A1 is an example of a first portion, and a portion positioned in the second region A2 is an example of a second portion.

In the laminated glass 110M, the ceramic layer 114M is different from the ceramic layer 114 shown in FIG. 3 in shape in a plan view in order to bypass a camera 30. The camera 30 is attached to an upper portion of the window glass 100M2 for vehicle inside the room as an example, and more specifically, may be attached in place of the communication instrument 20 shown in the upper portion of the window glass 100 for vehicle in FIG. 1A inside the room. The camera 30 is mounted on the vehicle 10 for imaging the forward side of the vehicle 10, and acquires an image for ADAS (Advanced Driver-Assistance Systems) of the vehicle 10 as an example.

The ceramic layer 114M has a protruding portion 114MA in the central portion in the right-left direction in the upper portion of the laminated glass 110M. The protruding portion 114MA protrudes from the circumferential edge portion of the laminated glass 110 in the downward direction of the window glass 100M2 for vehicle in the first region A1, and is provided in a portion surrounding the camera 30 in a plan view. The protruding portion 114MA is provided with an opening 114MB positioned in front of the camera 30. The opening 114MB is a portion in which the ceramic layer 114M is not formed, and is a portion included in an imaging field of view of the camera 30. The imaging field of view of the camera 30 is a range in which the camera 30 can acquire an image.

The camera 30 is attached to the laminated glass 110M by fixing a bracket made of resin or the like to the main surface 112B of the glass plate 112 inside the room with an adhesive or the like in a state in which the camera 30 is fixed to the bracket, as an example. The camera 30 is attached to the laminated glass 110M so as to have a lens facing the forward side of the vehicle body 11 through the opening 114MB. Note that the bracket or the like may have a ventilation hole or the like so that an inner space of the bracket or the like communicates with a room space of the vehicle 10.

In the window glass 100M2 for vehicle having such a laminated glass 110M, the electric wave propagation region 21A is positioned below the protruding portion 114MA of the ceramic layer 114M.

The upper edge bus bar 120TM is bent into a crank shape along the protruding portion 114MA of the ceramic layer 114M. More specifically, the upper edge bus bar 120TM extends in the X-axis direction in the second region A2 along the upper edge of the laminated glass 110M and is bent into a crank shape in the first region A1 along the protruding portion 114MA of the ceramic layer 114M. Note that the lower edge bus bars 120B shown in FIG. 7 are identical to the lower edge bus bars 120B shown in FIG. 3.

Thus, a length in the Y-axis direction in the first region A1 between the upper edge bus bar 120TM and the lower edge bus bar 120B is shorter than a length in the Y-axis direction in the second region A2 between the upper edge bus bar 120TM and the lower edge bus bar 120B.

The heating wires 130M2 have first heating wires 131M2 and the second heating wires 132. The second heating wires 132 are identical to the second heating wires 132 shown in FIG. 3. The first heating wires 131M2 have a diameter equal to a diameter of the second heating wires 132, and are provided at the first pitch equal to the first pitch in the X-axis direction between the first heating wires 131 shown in FIG. 3. A length of the first heat transfer line 131M2 in the Y-axis direction is shorter than a length of the second heat transfer line 132 in the Y-axis direction. Thus, a resistance value across both ends of the first heat transfer line 131M2 is lower than a resistance value across both the ends of the second heat transfer line 132.

The first heating wires 131M2 and the second heating wires 132 are supplied with the same amount of electrical power because of being connected between the upper edge bus bars 120TM and the lower edge bus bars 120B. Since the first heating wires 131M2 are shorter and lower in resistance value than the second heating wires 132, a larger amount of electrical current flows to the first heating wires 131M2 than to the second heat transfer line 132. As a result, the amount of heat generation of each of the first heating wires 131M2 is larger than the amount of heat generation of each of the second heating wires 132.

In this manner, the heat generation distributions in the first region A1 and the second regions A2 can be equalized, and transmittivity of an electric wave transmitted/received by the communication instrument 20 can be increased in the first region A1 by making the first pitch between the first heating wires 131M2 wider than the second pitch between the second heating wires 132.

As described above, in the window glass 100M2 for vehicle, the first region A1 is positioned in the central portion in the width direction of the vehicle body 11, and the second regions A2 are positioned at both the sides of the first region A1 in the width direction of the vehicle body 11. The upper edge bus bars 120TM have a first portion positioned in the first region A1 and two second portions positioned in the second regions A2 positioned at both the sides of the first region A1. The upper edge bus bars 120TM are bent into a crank shape between the first portion and the two second portions. The first portion is away from the upper edge of the laminated glass 110 to be positioned closer to the lower edge of the laminated glass 110 than the two second portions are.

Thus, a distance between the upper edge bus bars 120TM and the lower edge bus bars 120B in the first region A1 is shorter than a distance between the upper edge bus bars 120TM and the lower edge bus bars 120B in the second regions A2. In other words, since the first heating wires 131M2 are shorter and lower in resistance value than the second heating wires 132, a larger amount of electrical current flows to the first heating wires 131M2. Thus, more uniform heat generation distributions are obtained in the first region A1 and the second regions A2 with effective transmittivity of an electric wave ensured in the first region A1.

Therefore, the window glass 100M2 for vehicle that can satisfy both of effective transmittivity of an electric wave and more uniform heat generation distributions can be provided.

Note that the first heating wires 131M2 can be made thicker than the second heating wires 132. When the first heating wires 131M2 in the first region A1 are made thicker, the first heating wires 131M2 have a still lower resistance value, whereby it becomes much easier for electrical current to flow, and the amount of heat generation of each of the first heating wires 131M2 can be made larger than in the case in which the first heating wires 131M2 and the second heating wires 132 are equal in diameter. Thus, the first pitch between the first heating wires 131M2 in the X-axis direction, for example, can be made still wider.

Instead of using the upper edge bus bars 120TM bent into a crank shape along the protruding portion 114MA of the ceramic layer 114M, the following configuration may be adopted. Similarly to the two upper edge bus bars 120TS and the single upper edge bus bar 120TC of the first modification, the upper edge bus bars may be divided into the first region A1 and the second regions A2, and in order to bypass the protruding portion 114MA of the ceramic layer 114M, the upper edge bus bar 120TC in the first region A1 may be arranged closer to the −Y-axis direction side than the upper edge bus bars 120TS in the second regions A2 are. In this case, on the lower edge side, the lower edge bus bar 120BC may be provided in the first region A1, and the lower edge bus bars 120BS may be provided in the second regions A2. Electrical power to be supplied across the upper edge bus bar 120TC and the lower edge bus bar 120BC in the first region A1 may be made larger than electrical power to be supplied across the upper edge bus bars 120TS and the lower edge bus bars 120BS in the second regions A2. In this case, the first heating wires 131M2 in the first region A1 and the second heating wires 132 in the second regions A2 may be equal in diameter. Since the first heating wires 131M2 in the first region A1 are shorter and lower in resistance value than the second heating wires 132 in the second regions A2, the first pitch between the first heating wires 131M2 in the X-axis direction can be made still wider. In addition, if the first heating wires 131M2 are made thicker than the second heating wires 132, the first pitch between the first heating wires 131M2 in the X-axis direction can be made still wider.

In this case, since the upper edge bus bar 120TC is away from the upper edge of the laminated glass 110 to be positioned closer to the lower edge of the laminated glass 110 than the upper edge bus bars 120TS are, the distance between the upper edge bus bar 120TC and the lower edge bus bar 120BC in the first region A1 is shorter than the distance between the upper edge bus bars 120TS and the lower edge bus bars 120BS in the second regions A2. In other words, since the first heating wires 131M1 are shorter and lower in resistance value than the second heating wires 132, a larger amount of electrical current flows to the first heating wires 131M1. Thus, more uniform heat generation distributions are obtained in the first region A1 and the second regions A2 with effective transmittivity of an electric wave ensured in the first region A1.

Therefore, the window glass 100M1 for vehicle that can satisfy both of effective transmittivity of an electric wave and more uniform heat generation distributions can be provided.

Although the exemplary window glasses for vehicle of the present disclosure have been described above, the present disclosure is not limited to the specifically disclosed embodiments, and can be variously modified or altered without departing from the scope of claims. Such variations are not to be regarded as a departure from the spirit and scope of the disclosure, and all such modifications as would be obvious to one skilled in the art are intended for inclusion within the scope of the following claims.

What is claimed is:

1. A window glass for vehicle, comprising:
a laminated glass including a first glass plate having a first main surface and a second main surface, a second glass plate having a third main surface and a fourth main surface, and an intermediate film provided between the second main surface and the third main surface, the laminated glass being provided in an opening of a vehicle body;
an upper edge bus bar provided between the second main surface and the third main surface along an upper edge of the laminated glass;
a lower edge bus bar provided between the second main surface and the third main surface along a lower edge of the laminated glass; and
a heating section provided between the second main surface and the third main surface and connected between the upper edge bus bar and the lower edge bus bar, wherein
the laminated glass has a first region in which a communication unit is positioned in a width direction of the vehicle body and a second region other than the first region, and
the heating section has first heating wires provided in the first region and connected between the upper edge bus bar and the lower edge bus bar and second heating wires provided in the second region and connected between the upper edge bus bar and the lower edge bus bar, and a first pitch between the first heating wires in the width direction of the vehicle body is wider than a second pitch between the second heating wires in the width direction of the vehicle body.

2. The window glass for vehicle according to claim 1, wherein the first heating wires are thicker than the second heating wires.

3. The window glass for vehicle according to claim 1, wherein the first region is positioned in a central portion or at an end in the width direction of the vehicle body.

4. The window glass for vehicle according to claim 1, wherein
the upper edge bus bar has a first upper edge bus bar positioned in the first region and a second upper edge bus bar positioned in the second region,
the lower edge bus bar has a first lower edge bus bar positioned in the first region and a second lower edge bus bar positioned in the second region,
the first heating wires are connected between the first upper edge bus bar and the first lower edge bus bar,
the second heating wires are connected between the second upper edge bus bar and the second lower edge bus bar, and
electrical power supplied to the first heating wires via the first upper edge bus bar and the first lower edge bus bar is larger than electrical power supplied to the second heating wires via the second upper edge bus bar and the second lower edge bus bar.

5. The window glass for vehicle according to claim 4, wherein the first upper edge bus bar is away from the upper edge of the laminated glass to be positioned closer to the lower edge of the laminated glass than the second upper edge bus bar is.

6. The window glass for vehicle according to claim 1, wherein
the first region is positioned in a central portion in the width direction of the vehicle body,
the second region includes second regions positioned on both sides of the first region in the width direction of the vehicle body,
the upper edge bus bar has a first portion positioned in the first region and two second portions positioned in the second regions positioned on both the sides of the first region, and
the upper edge bus bar is bent into a crank shape between the first portion and the two second portions, and the first portion is away from the upper edge of the laminated glass to be positioned closer to the lower edge of the laminated glass than the two second portions are.

7. The window glass for vehicle according to claim 1, wherein the first pitch and the second pitch are constant between the upper edge bus bar and the lower edge bus bar.

8. The window glass for vehicle according to claim 1, wherein
a frequency of an electric wave transmitted or received by the communication unit is a frequency in a band of 6 GHz or a frequency of 6 GHz or less, and
the first pitch is 4 mm or less.

9. The window glass for vehicle according to claim 1, wherein an electric wave transmitted or received by the communication unit is a vertically polarized wave or circularly polarized wave.
